(19) United States
(12) Patent Application Publication
(10) Pub. No.: US 2022/0314420 A1
(43) Pub. Date: Oct. 6, 2022

(54) AUTO ADJUSTABLE SPANNER HAND TOOL SYSTEM, ADJUSTABLE DRIVETRAIN TOOL APPARATUS WITH AUTO ADJUSTABLE SPANNER FEATURE, AND METHODS OF USE

(71) Applicant: Fernando Newcomb, Hong Kong (HK)

(72) Inventor: Fernando Newcomb, Hong Kong (HK)

(21) Appl. No.: 17/706,922

(22) Filed: Mar. 29, 2022

Related U.S. Application Data
(60) Provisional application No. 63/169,275, filed on Apr. 1, 2021.
(60) Provisional application No. 63/241,012, filed on Sep. 6, 2021.

(51) Int. Cl. B25F 5/00; B25B 21/00

(52) U.S. Cl. CPC B25F 5/001; B25B 21/004; B25B 21/002

(57) ABSTRACT

An auto adjustable spanner hand tool system, adjustable drivetrain tool apparatus with auto adjustable spanner feature, and methods of use are presented. More specifically, and without limitation, the present disclosure is a hand tool device with multi-function and multi-directional capacity for use in various applications. More specifically, and without limitation, the present disclosure is designed to provide multi-directional functionality and automation in a rotational spanner hand tool. However, the present disclosure is not limited to these novel and inventive improvements, and it may further be adapted for a variety of purposes.

### CROSS-REFERENCE TO RELATED APPLICATIONS

The present application claims priority to the U.S. Provisional Patent Application No. 63/169,275 which was filed on Apr. 1, 2021, which is hereby incorporated by reference herein in its entirety, including any figures, tables, or drawings.

Additionally, the present application claims priority to the U.S. Provisional Patent Application No. 63/241,012 which was filed on Sep. 6, 2021, which is hereby incorporated by reference herein in its entirety, including any figures, tables, or drawings.

### FIELD OF THE DISCLOSURE

The present disclosure relates generally to a hand tool. More specifically and without limitation, the present disclosure relates to an auto-adjustable spanner hand tool system, adjustable drivetrain tool apparatus with auto adjustable spanner feature, and methods of use. More specifically, and without limitation, the present disclosure is a hand tool device with multi-function and multi-directional capacity for use in various applications. More specifically, and without limitation, the present disclosure is designed to provide multi-directional functionality and automation in a rotational spanner hand tool. However, the present disclosure is not limited to these novel and inventive improvements, and it may further be adapted for a variety of purposes.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Sentinel Systems Limited. All rights reserved.

### BACKGROUND OF THE DISCLOSURE

Tools are well known in the art. Generally speaking, a tool can be any object which assists a user in a task they are trying to accomplish. More specifically, a tool generally modifies features in the environment. As those who are familiar with the art, tool is commonly a term used for mechanical-like functions such as cutting, moving, manipulating, guiding, measuring, shaping, fastening, a combination thereof, and the like. Commonly thought of tools in the art include hammers, screwdrivers, wrenches, tape measures, pliers, anvils, nail guns, jigs, trowels, saws, clamps, and many more. Many of these tools can be implemented by a single user by holding and/or manipulating. In this way, hand tools are also well known in the art.

Spanners are a type of hand tool. A spanner, or more commonly known as a wrench, is an open ended tool which allows a user to twist and/or manipulate an object. Commonly, an adjustable spanner also includes a moveable jaw which allows a user to change sizes of the head so that the wrench can be used with various size bolts and the like. In this way, a commonly used term to describe this known tool is a wrench.

Wrenches have many uses from mechanics to construction and the like. Wrenches have changed little in the last 100 years and continue to be used in similar ways today. Wrenches come in various sizes from very small wrenches used in electronics, to very large wrenches which can only be controlled by large powered machines such as in the shipping industry and the like. Little improvements have been made to wrenches over the years, the materials used to make them primarily, or how they are lubricated (if lubricated at all).

Drivetrains are well known in the art. A drivetrain tends to be associated with the motor of a vehicle, but in any case, can be considered a group of components that deliver power. In the instance of a vehicle, the drivetrain is a group of components that transfer power from the engine or motor to the driving wheels of the vehicle. In this way, a drivetrain is oftentimes considered in association with a motor and/or power generator of some sort.

Said another way, most drivetrains have a functionality that is to couple power that is produced by an engine and/or motor to driving wheels and or driving mechanisms that use mechanical energy. Oftentimes, and as is the case with vehicles, this mechanical energy is converted into a rotational force. Known drivetrains, such as those found in vehicles, are complicated and expensive to produce, and these drivetrains tend to be very large. Oftentimes, in the environment, rotational functionality and/or the rotational use of a device is critical to operation.

Tools are well known in the art. Hand tools, particularly, have been around since Homo sapiens first began using a rock or other objects to aid in their task. Hand tools, as a few examples, are often considered to be hammers, cutters, hand saws, ratchets, screwdrivers, sockets, wrenches, vises, and many others, just to name a few. Hand tools often require a rotation, such as a rocket wrench turning and/or twisting on a bolt. As another example, wrenches will twist on a nut to tighten and/or loosen. As another example, pliers will twist and/or rotate about an axis to tighten and/or loosen. As another example, screwdrivers will rotate about an axis to tighten and/or loosen. As another example, ratchets will rotate about an axis to tighten and/or loosen. These examples of rotation about an axis are just a few of the many tools that have been developed to aid humans in various tasks.

These static and/or stationary tools are excellent examples of helpful tools. However, these tools are static and present a number of limitations both in functionality, speed, strength, and the like. A human hand and/or arm must constantly twist and reset and twist again to operate these tools. For these and many other reasons, the operation of these types of tools can be difficult, laborious, and cause strain.

Drills and/or automated tools have been developed in the art to aid a user in rotational application. However, these power tools, such as drills are oftentimes heavy and/or bulky and/or they may lack desired functionality. One such example is a power drill. A power drill is a rotationally directed tool which often aids in screwing, ratcheting, and the like. However, a power tool is often large, making it hard to fit into small places, often requires a large, heavy battery, and has many limitations on functionality. Furthermore, the drivetrain of these tools can cause the tool to lose a lot of energy and causes the tool to be large.

Thus, there is a need in the art for a new wrench that is easier to use. There are many circumstances where a user doesn't have the strength needed to use the wrench. Similarly, there are many circumstances where the shape and design of a commonly known wrench are not suitable. This may be because of the tight confines within which a user is working and the like. Therefore, there is a need in the art, which has gone unaddressed for over 100 years for a wrench which suits these and other needs, for a wrench which is automated to provide strength and/or enhanced strength for a user, for a wrench which can fit various sizes without any adjustments needed by a user, for a wrench that can be used in tight spaces, for a wrench that can manipulate an object while a user holds their hand stationary and the like.

Thus, there is a need in the art for a spanner tool system that is lightweight, small, energy efficient, and easy to use. Thus, there is also a need in the art for a simple drivetrain that can be large, energy efficient, and easy to use. Furthermore, there is a need for this drivetrain in a wide variety of applications, such as some of the various hand tools mentioned herein. In other words, having a drivetrain which is small and efficient enough to work with hand tools, so that hand tools don't have to be converted to power tools, such as large bulky drills, can save time and effort. This type of drivetrain is needed in the art. Said another way, there is a need in art for a drivetrain which could apply to a ratchet, a screwdriver, a wrench, a spanner, a fastening tool, a chisel, a punch, a stamp, a tap, a small hand saw, a pick, a hammer, a cutter, a hex tool, a multi tool, and a number of other tools which would allow the tool to fit in a similarly small spatial area and provide the enhanced functionality, such that a user might tighten and/or loosen a bolt in a hard to reach place simply by pressing a button on a device. The present disclosure provides such a drivetrain, that is unique, efficient, can be small, and solves a number of longstanding issues facing the art.

The spanner tool system, drivetrain system, and other disclosures, presented herein are not limited to hand tools. Hand tools are just one of many examples of applications of such a drive train. The drivetrain presented herein may also be very large such that the drivetrain can be applied in any capacity in which bi-directional and/or multi-directional movements are desired. For this reason, the examples, embodiments, and applications of the drivetrain system presented herein, among others, are hereby contemplated for use.

### SUMMARY OF THE DISCLOSURE

The purpose of this disclosure is to provide the state of the art with a spanner tool system, a drivetrain system, a drivetrain tool apparatus, and methods of use. More specifically, and without limitation, the present disclosure provides the state of the art, with a lightweight, potentially very small, energy efficient, easy to use drive train. Furthermore, and without limitation, the present disclosure provides the state of the art with these features in what is a “simple” drivetrain such that the drivetrain is durable and easy to repair. Furthermore, the present disclosure provides the state of the art with a drivetrain that can be implemented in a variety of applications.

The present disclosure, in one embodiment, as one example, presents an auto-adjustable spanner tool system. In this way, the present disclosure provides the state of the art with an automated spanner tool system which self-adjusts. Of course, these “automated” features are conducted by the tool itself in ways further described in this disclosure and presented herein. Furthermore, the present disclosure provides the state of the art with an easy to use spanner tool which can be held still while completing an operation and which fits into hard to reach spaces, and is durable.

The present disclosure, in one embodiment, as one example, presents a drivetrain for use in a hand tool. In this way, and in this application, the drivetrain can be applied to lightweight and potentially very small hand tools. Said another way, the present drivetrain can turn common hand tools into power tools without adding weight or size. In this way, the present drivetrain provides for a means for automating and/or powering a hand tool. This provides the state of the art with both convenience and functionality, all while providing the state of the art with durability and strength.

This type of drivetrain is needed in the art. Said another way, there is a need in art for a drivetrain which could apply to a ratchet, a screwdriver, a wrench, a spanner, a fastening tool, a chisel, a punch, a stamp, a tap, a small hand saw, a pick, a hammer, a cutter, a hex tool, a multi tool, and a number of other tools which would allow the tool to fit in a similarly small spatial area and provide the enhanced functionality, such that a user might tighten and/or loosen a bolt in a hard to reach place simply by pressing a button on a device. In this way, the present disclosure provides such a drivetrain, that is unique, efficient, can be small, and solves a number of longstanding issues facing the art.

The drivetrain system presented herein, as one example, is not limited to hand tools. Hand tools are just one of many examples of applications of such a drive train. The drivetrain presented herein may also be very large such that the drivetrain can be applied in any capacity in which bi-directional and/or multi-directional movements are desired. For this reason, the examples, embodiments, and applications of the drivetrain system presented herein, among others, are hereby contemplated for use. Other examples may include, but are not limited to a variety of powertrain systems, vehicles, boating, kitchen appliances, yard tools, other tools, and more.

Said another way, and as one example of an embodiment of the disclosure herein, the present disclosure provides the state of the art with a powerful drivetrain capable of strong torque functionalities for rotational forces and the like that can fit within the palm of the hand of a user in the form of an auto-adjusting spanner tool system. In this way, the drivetrain provided herein can be implemented in various ways due to size, strength, and durability.

Thus, it is a primary object of the disclosure to provide an auto adjustable spanner hand tool system, adjustable drivetrain tool apparatus with auto adjustable spanner feature, and methods of use that improve upon the state of the art.

Another object of the disclosure is to provide an auto adjustable spanner hand tool system, adjustable drivetrain tool apparatus with auto adjustable spanner feature, and methods of use that are easy to use.

Yet another object of the disclosure is to provide an auto adjustable spanner hand tool system, adjustable drivetrain tool apparatus with auto adjustable spanner feature, and methods of use that can be implemented in a variety of applications.

Another object of the disclosure is to provide an auto adjustable spanner hand tool system, adjustable drivetrain tool apparatus with auto adjustable spanner feature, and methods of use that are durable.

Yet another object of the disclosure is to provide an auto adjustable spanner hand tool system, adjustable drivetrain tool apparatus with auto adjustable spanner feature, and methods of use that have minimal parts.

Another object of the disclosure is to provide an auto adjustable spanner hand tool system, adjustable drivetrain tool apparatus with auto adjustable spanner feature, and methods of use that are lightweight.

Yet another object of the disclosure is to provide an auto adjustable spanner hand tool system, adjustable drivetrain tool apparatus with auto adjustable spanner feature, and methods of use that are energy efficient.

Another object of the disclosure is to provide an auto adjustable spanner hand tool system, adjustable drivetrain tool apparatus with auto adjustable spanner feature, and methods of use that are safe.

Yet another object of the disclosure is to provide an auto adjustable spanner hand tool system, adjustable drivetrain tool apparatus with auto adjustable spanner feature, and methods of use that are bi-directional.

Another object of the disclosure is to provide an auto adjustable spanner hand tool system, adjustable drivetrain tool apparatus with auto adjustable spanner feature, and methods of use that are multi-directional.

Yet another object of the disclosure is to provide an auto adjustable spanner hand tool system, adjustable drivetrain tool apparatus with auto adjustable spanner feature, and methods of use that can be held in one hand of a user.

Another object of the disclosure is to provide an auto adjustable spanner hand tool system, adjustable drivetrain tool apparatus with auto adjustable spanner feature, and methods of use that are relatively inexpensive.

Yet another object of the disclosure is to provide an auto adjustable spanner hand tool system, adjustable drivetrain tool apparatus with auto adjustable spanner feature, and methods of use that can be held within the palm of a user.

Another object of the disclosure is to provide a drivetrain system, a drivetrain tool apparatus, and methods of use that are powerful.

Yet another object of the disclosure is to provide an auto adjustable spanner hand tool system, adjustable drivetrain tool apparatus with auto adjustable spanner feature, and methods of use that can provide rotational forces.

Another object of the disclosure is to provide an auto adjustable spanner hand tool system, adjustable drivetrain tool apparatus with auto adjustable spanner feature, and methods of use that can be used as an all inclusive spanner.

Yet another object of the disclosure is to provide an auto adjustable spanner hand tool system, adjustable drivetrain tool apparatus with auto adjustable spanner feature, and methods of use that can be used to automatically manipulate an object.

Another object of the disclosure is to provide an auto adjustable spanner hand tool system, adjustable drivetrain tool apparatus with auto adjustable spanner feature, and methods of use that can be implemented with an auto-adjusting spanner.

Yet another object of the disclosure is to provide an auto adjustable spanner hand tool system, adjustable drivetrain tool apparatus with auto adjustable spanner feature, and methods of use that provide the state of the art with an auto-adjusting universal spanner tool capable of adjusting objects of various size and shape.

Another object of the disclosure is to provide an auto adjustable spanner hand tool system, adjustable drivetrain tool apparatus with auto adjustable spanner feature, and methods of use that includes a safety lock.

Yet another object of the disclosure is to provide an auto adjustable spanner hand tool system, adjustable drivetrain tool apparatus with auto adjustable spanner feature, and methods of use that includes a variable speed control.

Another object of the disclosure is to provide an auto adjustable spanner hand tool system, adjustable drivetrain tool apparatus with auto adjustable spanner feature, and methods of use that can be powered by electrical power.

Yet another object of the disclosure is to provide an auto adjustable spanner hand tool system, adjustable drivetrain tool apparatus with auto adjustable spanner feature, and methods of use that can be implemented in ratchet rotational and/or torque applications which are bi-directional.

Another object of the disclosure is to provide an auto adjustable spanner hand tool system, adjustable drivetrain tool apparatus with auto adjustable spanner feature, and methods of use that can be implemented in ratchet rotational and/or torque applications which are multi-directional.

Yet another object of the disclosure is to provide an auto adjustable spanner hand tool system, adjustable drivetrain tool apparatus with auto adjustable spanner feature, and methods of use that can change direction through simple button mechanisms and/or simple controls.

Another object of the disclosure is to provide an auto adjustable spanner hand tool system, adjustable drivetrain tool apparatus with auto adjustable spanner feature, and methods of use that are user friendly.

Yet another object of the disclosure is to provide an auto adjustable spanner hand tool system, adjustable drivetrain tool apparatus with auto adjustable spanner feature, and methods of use that can be applied in a variety of applications for both sizing and strength requirements.

Another object of the disclosure is to provide an auto adjustable spanner hand tool system, adjustable drivetrain tool apparatus with auto adjustable spanner feature, and methods of use that easily fit within confined spaces.

Yet another object of the disclosure is to provide an auto adjustable spanner hand tool system, adjustable drivetrain tool apparatus with auto adjustable spanner feature, and methods of use that includes the ability to change the head of the spanner such that the head is a different size and/or fits objects of varying shapes.

Another object of the disclosure is to provide an auto adjustable spanner hand tool system, adjustable drivetrain tool apparatus with auto adjustable spanner feature, and methods of use that can be implemented in any orientation.

Yet another object of the disclosure is to provide an auto adjustable spanner hand tool system, adjustable drivetrain tool apparatus with auto adjustable spanner feature, and methods of use that can be implemented with a variety of different power supply types.

Another object of the disclosure is to provide an auto adjustable spanner hand tool system, adjustable drivetrain tool apparatus with auto adjustable spanner feature, and methods of use that are durable against moisture.

Yet another object of the disclosure is to provide an auto adjustable spanner hand tool system, adjustable drivetrain tool apparatus with auto adjustable spanner feature, and methods of use that are power efficient.

Another object of the disclosure is to provide an auto adjustable spanner hand tool system, adjustable drivetrain tool apparatus with auto adjustable spanner feature, and methods of use that are relatively cost effective for repairing and implementing repairs of existing applications.

Yet another object of the disclosure is to provide an auto adjustable spanner hand tool system, adjustable drivetrain tool apparatus with auto adjustable spanner feature, and methods of use that are relatively cost effective for time efficiency in manufacturing and/or repairing.

These and other objects, features, or advantages of the present disclosure will become apparent from the specification and claims.

### BRIEF DESCRIPTION OF THE DRAWINGS

FIG. 1 is a perspective view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

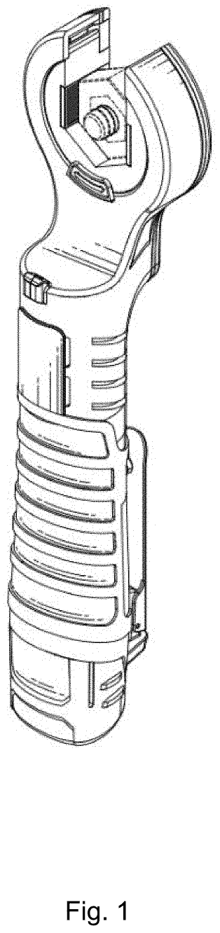

FIG. 2 is a front view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

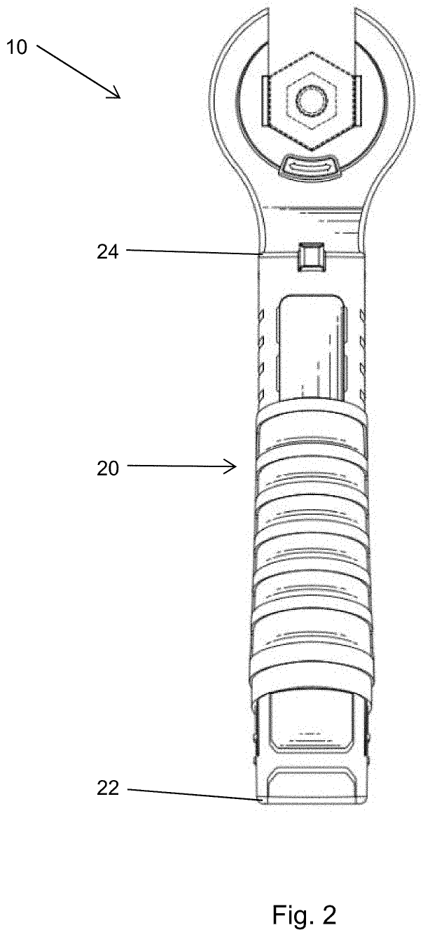

FIG. 3 is a rear view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

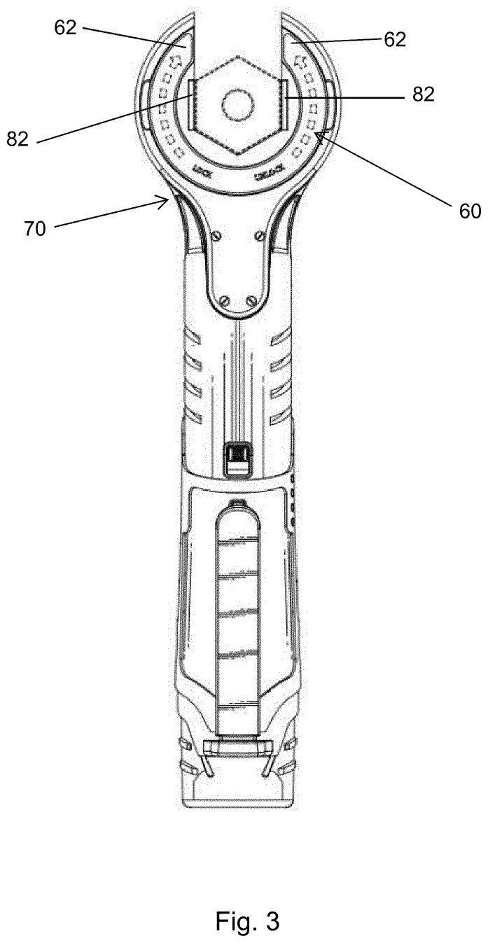

FIG. 4 is a side view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

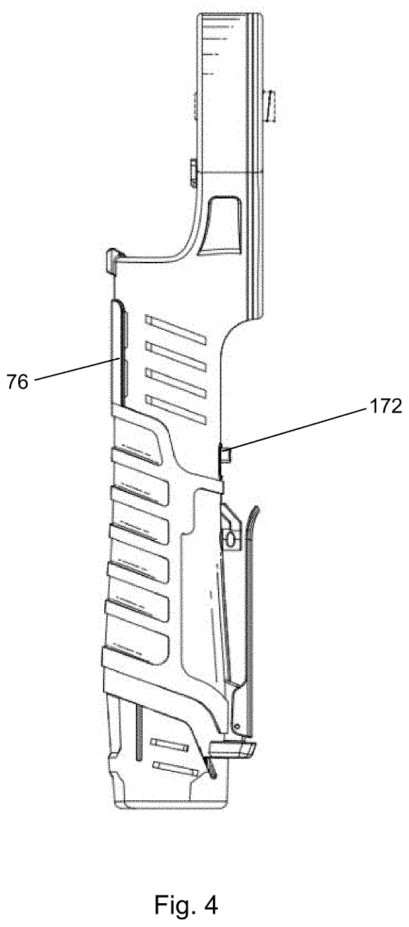

FIG. 5 is a side view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

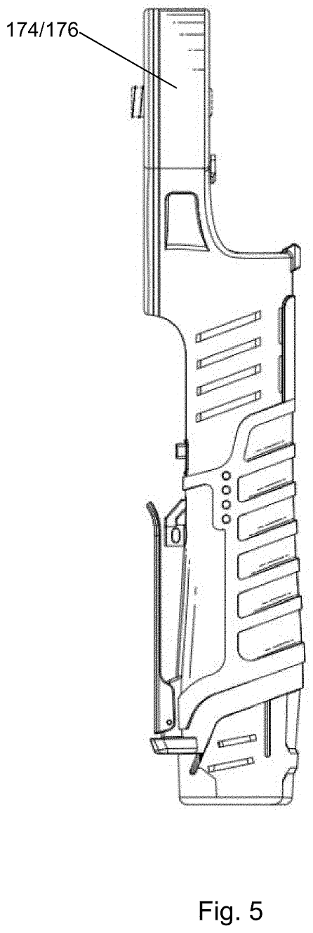

FIG. 6 is a top view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

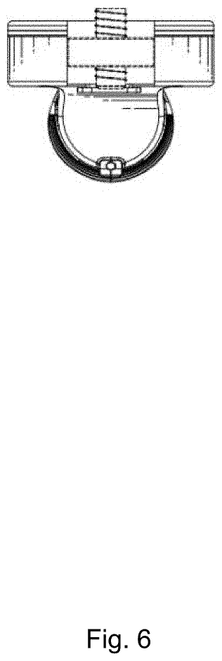

FIG. 7 is a bottom view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

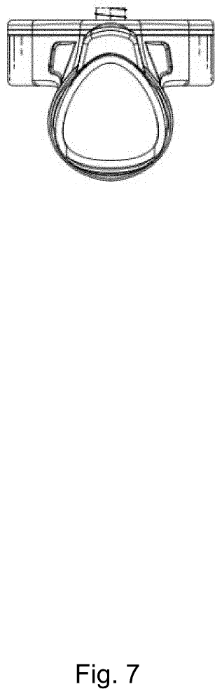

FIG. 8 is a perspective view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

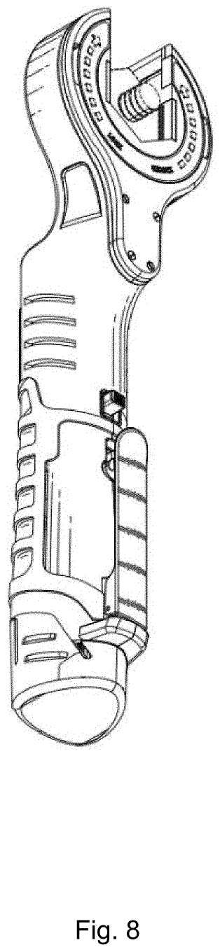

FIG. 9 is a perspective, isometric view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

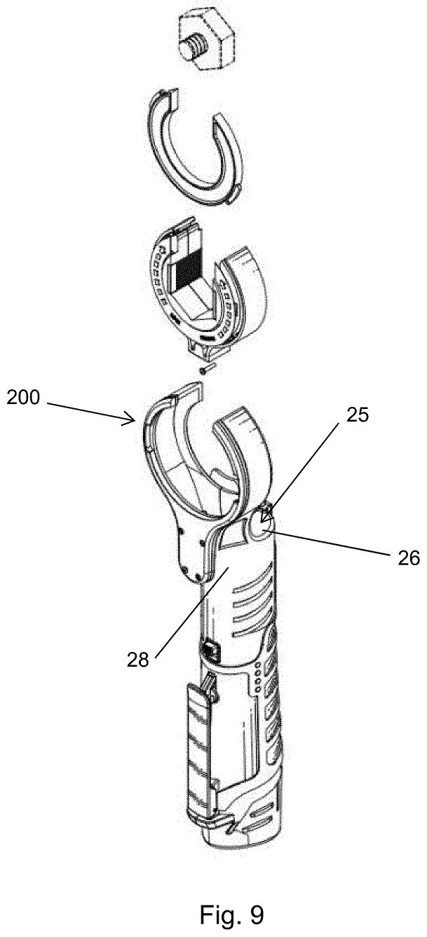

FIG. 10 is a perspective view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

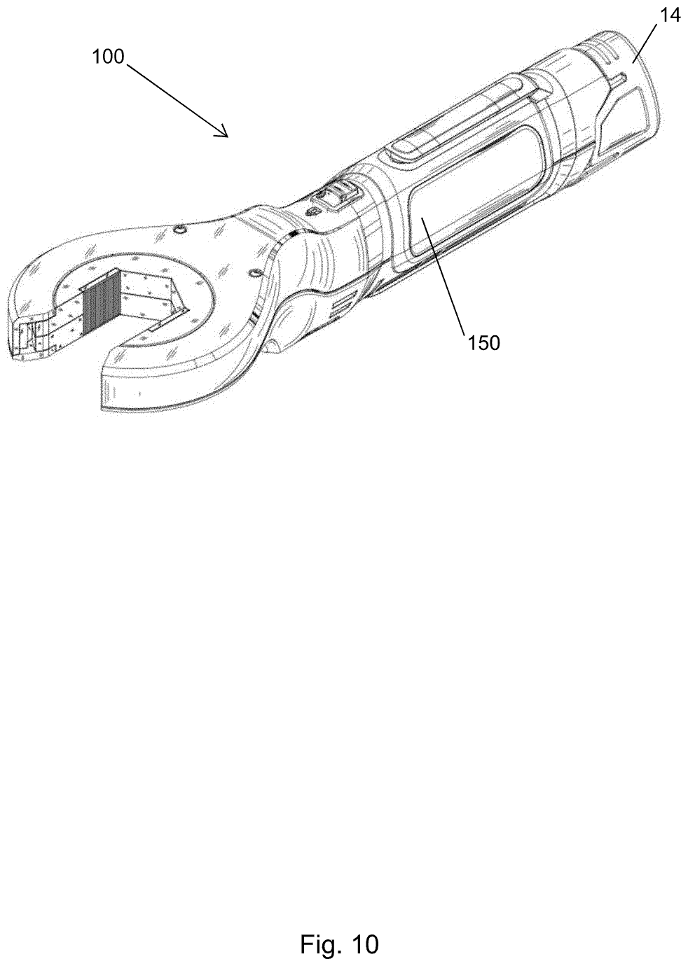

FIG. 11 is a front view of the auto adjustable spanner hand tool system, adjustable drivetrain tool apparatus with auto adjustable spanner feature, and methods of use; the view showing an auto adjustable spanner hand tool system; the view showing the spanner tool system engaged with a desired target device; the view showing a desired target device; the view showing the spanner tool system engaged with the target device between a first grip and second grip.

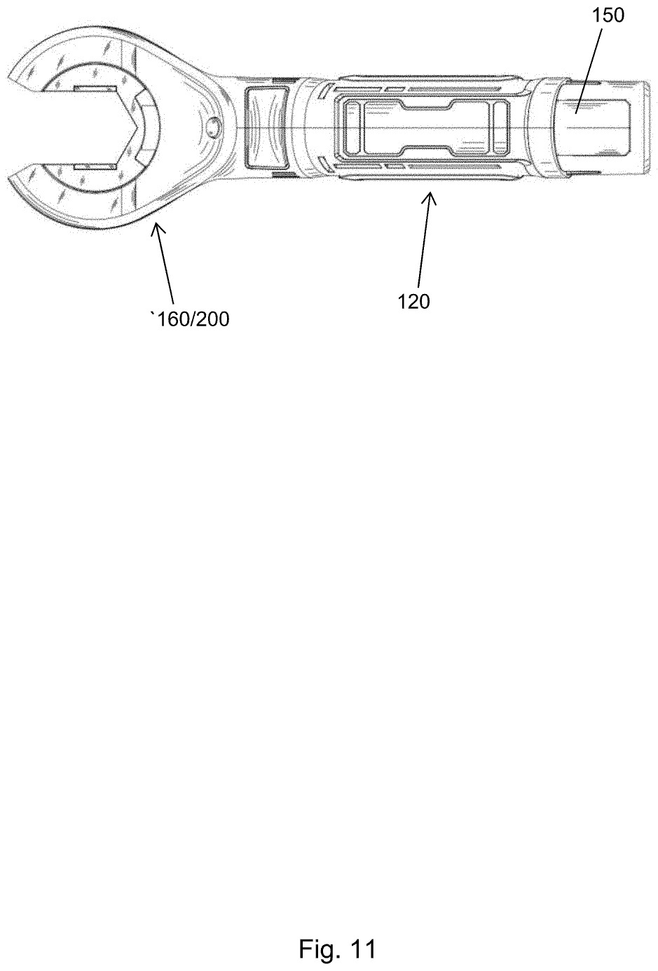

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

All illustrations of the drawings are for the purpose of describing selected versions of the present disclosure and are not intended to limit the scope of the present disclosure.

Although the disclosure has been explained in relation to its preferred embodiment, it is to be understood that many other possible modifications and variations can be made without departing from the spirit and scope of the disclosure.

The system disclosed herein provides the state of the art with an auto adjustable spanner hand tool system, adjustable drivetrain tool apparatus with auto adjustable spanner feature, and methods of use. More specifically, and without limitation, the present disclosure provides the state of the art, with a lightweight, energy efficient, easy to use automatically adjusting and automatically operating spanner tool.

Said another way, the system disclosed herein provides the state of the art with an auto adjustable spanner hand tool system, adjustable drivetrain tool apparatus with auto adjustable spanner feature, and methods of use. More specifically, and without limitation, the present disclosure provides the state of the art, with a lightweight, potentially very small, energy efficient, easy to use auto adjusting spanner tool. Furthermore, and without limitation, the present disclosure provides the state of the art with these features in what is a “simple” spanner tool such that the tool is durable, easy to use, and easy to repair. Furthermore, the present disclosure provides the state of the art with a spanner tool that can be implemented in a variety of applications.

The present disclosure or hand tool spanner system, in one embodiment, as one example, presents an auto adjusting spanner for use as a hand tool. In this way, and in this application, the spanner tool system provides for an automated and/or powered spanner hand tool. This provides the state of the art with both convenience and functionality, all while providing the state of the art with durability and strength.

This spanner hand tool (as presented herein) and/or hand tool spanner automatically adjusting and automatically operating system is needed in the art and provides the state of the art with a number of solutions to long-standing needs which have been plaguing the art. Said another way, there is a need in art for an auto adjusting spanner tool which could apply to a ratchet, a screwdriver, a wrench, a spanner, a fastening tool, a chisel, a punch, a stamp, a tap, a small hand saw, a pick, a hammer, a cutter, a hex tool, a multi tool, and a number of other tools which would allow the tool to fit in a similarly small spatial area and provide the enhanced functionality, such that a user might tighten and/or loosen a bolt in a hard to reach place simply by pressing a button on a device. In this way, the present disclosure provides such a spanner hand tool system that is unique, efficient, can be small, and solves a number of longstanding issues facing the art.

In other words, the spanner hand tool system presented herein, as one example, is not limited to hand tools. Hand tools are just one of many examples of applications of such automated systems. The auto adjusting hand tool presented herein may also be very large such that the spanner tool can be applied in any capacity in which bi-directional and/or multi-directional movements are desired.

Said another way, and as one example of an embodiment of the disclosure herein, the present disclosure provides the state of the art with a powerful auto adjusting spanner hand tool capable of strong torque functionalities for rotational forces and the like that can fit within the palm of the hand of a user. In this way, the drivetrain provided herein can be implemented in various ways due to size, strength, and durability.

Spanner Tool System

With reference to the figures, an auto-adjustable spanner hand tool system, adjustable drivetrain tool apparatus with auto adjustable spanner feature, and methods of use are presented herein (also known as “spanner tool”, or “spanner hand tool”, or “automatically adjusting spanner tool”, or “automatically operating spanner hand tool”, or simply “spanner tool system”). Spanner tool system 100 is formed of any suitable size, shape, and design and is configured to manipulate objects automatically as well as adjust to object sizes automatically.

In this way, and by one example, the spanner hand tool system 100 is configured to remove a nut from a bolt and or other surface. In this way, the spanner hand tool system 100 can be placed in location with the head of the spanner hand tool system 100 (to be further discussed herein) located around the nut. The spanner hand tool system 100 merely needs to be activated. At which point, the spanner hand tool system 100 will adjust the head to fit the size of the nut. Subsequently the rotation system can be activated by a user and/or automatically activated to twist and/or rotate the nut or other object in the desired direction.

In the arrangement shown, as one example, the spanner hand tool system 100 includes a user, a power supply 14, perhaps a plurality of batteries, a main body 120, may also include a storage compartment 150, also a head 160 and/or an interchangeable head 160, and a drivetrain system 10, among other features, components, functionality, controls, operations, and the like.

User:

In the arrangement shown, as one example, spanner tool system 100 may include a user. User is primarily described herein for ease of explanation. Typically, in the example of a hand tool, a user is one who is engaging with and or using the spanner hand tool. In the example, such as applying spanner hand tool system 100 to a vehicle and/or heavy piece of machinery, a user may be a person driving and/or operating the piece of heavy machinery and/or controlling the piece of equipment or the like. Furthermore, a user may also be one or more who is engaging in the assembly and/or repair of spanner tool system 100, and the like.

Power Supply:

In the arrangement shown, as one example, spanner tool system 100 includes a power supply 14 (also known as an “energy engine”, a “power engine”, an “energy supply”, a “battery”, a “plurality of batteries”, or simply an “engine”). Energy supply 14 is formed of any suitable size, shape, and design and is configured to provide energy to the spanner tool system 100. Power supply 14 in the arrangement shown, does not move such as other mechanical components of the system may “move”. Instead energy supply 14 is configured as a source of energy for the motor (to be further discussed herein).

In the arrangement shown, as one example, power supply 14 is formed of a rechargeable battery. The rechargeable battery, or storage battery, is an electrical battery designed to be charged, discharged, and recharged as many times as needed, as opposed to a disposable or primary batter, which is disposed of after use. However, a primary battery or disposable battery is also hereby contemplated for use. The rechargeable battery, in the arrangement shown, is formed of one or more electrochemical cells. In the arrangement shown, as one example, power supply 14 is formed of a rechargeable battery. However, the power supply may also consist of a plurality of rechargeable batteries and/or a plurality of batteries.

In the arrangement shown, as one example, the power supply 14 may also be formed of other power types and/or generators including, but not limited to solar power supply, natural gas or gas power supply in which an engine converts coal, gas, or other elements into mechanical energy, as well as other power supply types.

Furthermore, in the arrangement shown, power supply 14 may also include all necessary components, whether wires, conductors, cases, holders, and the like which provide for necessary connections and stabilization for power supply 14 components.

Main Body:

In the arrangement shown, as one example, spanner hand tool system 100 includes a main body 120 (also known as an “casing”, a “body”, a “grip body”, a “hand grip”, a “housing”, a “main housing”, or simply “body”). Main housing 120 is formed of any suitable size, shape, and design and is configured to house and hold various components of system 100. In the arrangement shown, as one example, main body 120 includes an internal housing, controls, indicators, electrical connections, an internal drivetrain, among other features and components.

In the arrangement shown, as one example, the main housing 120 is generally an elongated, hollow shape which is circular in structure when viewed as a cross section and is generally shaped as a rod or cylindrical rod. In this way, the designed main housing 120 is formed to enclose various features of the system 100, house and hold controls, and also displays indicators to a user. Furthermore, the main body 120 is also configured to, and may be waterproof or water resistant, hold electrical connections and other connections which cause system 100 to operate. In this way, the main housing 120 provides for functionality, control, and display, all in a compact easy to hold, and user friendly main housing 120.

Said another way, main body 120 is formed of any suitable size, shape, and design and is configured to house and hold the components of system 100. In this way, the main body 120 may be the power tool or hand tool which houses the various components of system 100. Main body 120 may be a vehicle which employs system 100, a piece of machinery which employs system 100, a kitchen tool and/or kitchen appliance which employs system 100, a hand tool which employs system 100, a yard tool which employs system 100, and the like. In this way, main body 120 may be open to the environment, may be closed to the environment, may be waterproof, may be water resistant, and/or have other sizing requirements and the like.

Storage Compartment:

In the arrangement shown, as one example, spanner hand tool system 100 may include a storage compartment 150 (also known as an “storage opening”, a simply known as a “compartment”). Storage compartment 150 is formed of any suitable size, shape, and design and is configured to hold various adaptable components, such as various heads, extra power supplies and the like.

Head:

In the arrangement shown, as one example, spanner hand tool system 100 includes a main body 120 (also known as an “casing”, a “body”, a “grip body”, a “hand grip”, a “housing”, a “main housing”, or simply “body”). Main housing 120 is formed of any suitable size, shape, and design and is configured to automatically adjust to the size needed and/or “span” and also automatically rotate, when triggered by a user. More about the head and head functionality is discussed herein.

Interchangeable embodiment: The head of the system, as shown herein, includes various shapes and embodiments. Additionally, an alternative embodiment includes a detachable head which can be exchanged for another head with a various type of function and/or use within the spanner tool system 100.

Drivetrain System

With reference to the figures, system 100 includes a drivetrain system, drivetrain apparatus, and methods of use 10 are presented herein (also known as “drivetrain system”, “drivetrain tool system”, “handheld drivetrain system”, “power tool system”, or simply “system). Drivetrain system 10 is formed of any suitable size, shape and design and is configured to provide a durable, efficient, and lightweight drivetrain for use in hand tools and other applications.

Said another way, the system disclosed herein provides the state of the art with a drivetrain system, a drivetrain tool apparatus, and methods of use. More specifically, and without limitation, the present disclosure provides the state of the art, with a lightweight, potentially very small, energy efficient, easy to use drive train. Furthermore, and without limitation, the present disclosure provides the state of the art with these features in what is a “simple” drivetrain such that the drivetrain is durable and easy to repair. Furthermore, the present disclosure provides the state of the art with a drivetrain that can be implemented in a variety of applications.

The drivetrain system 10, of the present disclosure, or hand tool drivetrain system, in one embodiment, as one example, presents a drivetrain for use in a hand tool. In this way, and in this application, the drivetrain can be applied to lightweight and potentially very small hand tools. Said another way, the present drivetrain can turn common hand tools into power tools without adding weight or size. In this way, the present drivetrain provides for a means for automating and/or powering a hand tool. This provides the state of the art with both convenience and functionality, all while providing the state of the art with durability and strength.

In this arrangement, and as is shown, this hand tool and/or hand tool drivetrain type of system is needed in the art and provides the state of the art with a number of solutions to long-standing needs which have been plaguing the art. Said another way, there is a need in art for a drivetrain which could apply to a ratchet, a screwdriver, a wrench, a spanner, a fastening tool, a chisel, a punch, a stamp, a tap, a small hand saw, a pick, a hammer, a cutter, a hex tool, a multi tool, and a number of other tools which would allow the tool to fit in a similarly small spatial area and provide the enhanced functionality, such that a user might tighten and/or loosen a bolt in a hard to reach place simply by pressing a button on a device. In this way, the present disclosure provides such a drivetrain, that is unique, efficient, can be small, and solves a number of longstanding issues facing the art.

In other words, the drivetrain system presented herein, as one example, is not limited to hand tools. Hand tools are just one of many examples of applications of such a drive train. The drivetrain presented herein may also be very large such that the drivetrain can be applied in any capacity in which bi-directional and/or multi-directional movements are desired. For this reason, the examples, embodiments, and applications of the drivetrain system presented herein, among others, are hereby contemplated for use. Other examples may include, but are not limited to a variety of powertrain systems, vehicles, boating, kitchen appliances, yard tools, other tools, and more.

Said another way, and as one example of an embodiment of the disclosure herein, the present disclosure provides the state of the art with a powerful drivetrain capable of strong torque functionalities for rotational forces and the like that can fit within the palm of the hand of a user. In this way, the drivetrain provided herein can be implemented in various ways due to size, strength, and durability.

Said another way, the term “drivetrain” is simply used as a term for ease of explaining the disclosure herein in relative terms. The term “drivetrain” outside of this disclosure commonly refers to a group of components that deliver power to the driving wheels, in a vehicle component. The term “drivetrain” for purposes of this disclosure is similar in that it describes a series of components that can deliver power. Similarly, the term, as used herein may refer to a single component or interconnected components forming a singular component, which deliver power and/or deliver energy and/or deliver movement.

In the arrangement shown, as one example, system 10 is formed of any suitable size, shape, and design and components so as to couple with the rotary (to be further discussed herein) to deliver a movement, whether this movement is rotational or the like. For purposes of this disclosure, and by example, a primary movement discussed in the rotational movement. This is only for ease of describing the disclosure herein.

Furthermore, in the arrangement shown, as an example of functionality, the present disclosure produces and/or transfers power. The power and/or energy is generally from a power source such as a motor or battery, or the like. The power is mechanically transferred through the disclosure herein to rotate the rotary. Said another way, the connection which transfers through the entire course of connections of the drivetrain physically links the power and/or engine component to the rotary.

In the arrangement shown, as one example, the engine and the rotary are located at opposite sides of the system. The rotary is located at an end which engages with a surface, a plurality of surfaces, or a particular object in which the energy is desired to be applied. In this way, the rotary can apply energy to a surface, a mechanical bolt and/or mechanical nut for twisting, at a desired speed. In the arrangement shown, as one example, the gear ratio and the like can be various. However, the present disclosure may also include a variable speed control (to be further discussed herein).

In this way, system 10 is configured to provide an efficient transfer of energy in a lightweight and easy to hold drivetrain system. While various sizes are contemplated for use among various applications where lightweight drivetrains are desired, the present disclosure includes a drivetrain light enough for a user to hold in their hand and use to transfer energy to a desired surface. Furthermore, system 10 is configured to have minimal components such that the system can achieve the desired functionality while have limited components in a compact format such that the hand tool (or other application) can be jostled around regularly while system 10 maintains its durability and lasts for a long time even with repeated dropping and operations of the system.

Said another way, system 10, as one example, provides the art with is a very small, compact hand tool which can be used as a motorized system. For this reason, the advantages of system 10, and particularly as applied to hand tools, will become apparent from the disclosure herein. A primary example will be providing power and automation to a number of hand tools, particularly of a certain size, which were unable to have power before, without growing the size of the tool. In this way, and in this arrangement, as shown, system 10 provides the state of the art with both convenience and functionality, all while providing the state of the art with durability and strength, in the form of an easy to use tool.

As one example, and as included herein, system 10 is applied to an auto-adjusting spanner. However, system 10 may be applied to heavy machinery, vehicles, a variety of factory machinery applications, yard tools, and many other applications. Furthermore, the auto-adjustable spanner as shown herein is a hand tool. However, system 10 may also be applied to various other hand tools such as, but not limited to, a ratchet, a screwdriver, a wrench, a fastening tool, a chisel, a punch, a stamp, a tap, a small hand saw, a pick, a hammer, a cutter, a hex tool, and a multi tool, and a number of other tools.

In this way, system 10 provides the art with a drivetrain that allows the tool (as applied to) to fit in a similarly small spatial area and provide the enhanced functionality, such that a user might tighten and/or loosen a bolt in a hard to reach place simply by pressing a button on a device. In this way, system 10 provides such a system that is unique, efficient, can be small, and solves a number of longstanding issues facing the art, and/or can be large while still being lightweight and efficient, while transferring energy efficiently.

Furthermore, system 10 is designed to be bi-directional and/or multi-directional. For this reason, the examples, embodiments, and applications of the drivetrain system presented herein, such as the auto-adjusting spanner, among others, are hereby contemplated for use. Other examples may include, but are not limited to a variety of powertrain systems, vehicles, boating, kitchen appliances, yard tools, other tools, and more.

In the arrangement shown, as one example, system 10 provides the state of the art with a powerful drivetrain capable of strong torque functionalities for rotational forces and the like that can fit within the palm of the hand of a user. In this way, the drivetrain system 10 provided herein can be implemented in various ways due to size, strength, and durability.

In the arrangement shown, as one example, system 10, may include a user 12, a power supply 14, may include a casement 20, a motor, a plurality of gears, a directional switch, a rotary gear 60, and an associated tool 70, among other components, features, surface type engagements and functionality.

Motor:

In the arrangement shown, as one example, system 10 includes a motor (also known as an “engine”). Motor is formed of any suitable size, shape, and design and is configured to convert one form of energy to another. In the case of the power supply 14 being formed of a battery, the motor converts the electrical energy of the battery into mechanical energy. In the case of a motor relying on thermal combustion and/or heat energy from a fuel source, the motor converts the heat energy into mechanical energy.

In the arrangement shown, as one example, the motor is operably connected to the flywheel and/or the plurality of gears. In this way, the motor is designed to operate and/or cause the flywheel and or plurality of gears to rotate. Furthermore, the motor is operably connected to the power supply 14 such that the power supply 14 can transfer energy to the motor, through conductance or other means.

Furthermore, the power supply 14 and the motor may be built into one and the same component such as a generator or the like.

Gears:

In the arrangement shown, as one example, spanner tool system 100 and/or system 10 includes a plurality of gears. Plurality of gears (or simply “gears”) may be formed of any suitable size, shape, and design and are configured to transfer energy safely and efficiently from the motor to the rotary 60. In this way, the plurality of gears may be formed of a series of wheels, each having a plurality of teeth and/or other frictional elements which are arranged in such a way that the movement of one gear causes the movement of a subsequent gear, when the gears are engaged.

In the arrangement shown, as one example, the plurality of gears may include, but are not limited to, a flywheel, a propeller shaft, and converter, among other gears, components, shafts, and the like.

Flywheel: In the arrangement shown, as one example, the plurality of gears include a flywheel (also known as “primary wheel”, “fly gear”, or simply “wheel”). Flywheel is formed of any suitable size, shape, and design and is configured to transfer energy from the motor into the remainder system of the drivetrain such that the flywheel is transferring the motor and/or rotational forces into the rest of the system. The flywheel may appear as a wheel which rotates about a center axis.

In the arrangement shown, the flywheel has a plurality of teeth. The plurality of teeth of the flywheel are arranged around the edge of the flywheel, such that the plurality of teeth can forcibly and operably cause the propeller shaft to spin and/or rotate about its center. In this way, the flywheel transfers energy to the propeller shaft (to be further described herein), such that the propeller shaft can cause the converter (to be further described herein) to move the rotary (to be further described herein).

A plurality of teeth of the flywheel are shown in the arrangement, as one example, however, other interactions are also contemplated for use. For example, a belt may exist which is engaged by the flywheel and the shaft so that the shaft is caused to rotate when the flywheel rotates, caused by a frictional force. Other arrangements are also hereby contemplated for use. For example the flywheel may have an outer covering with a high frictional coefficient, which interacts with the surface of the shaft (also perhaps having a high coefficient of friction, such that the rotation of the flywheel causes the shaft to rotate. These and other arrangements are hereby contemplated for use.

In yet another arrangement, the shaft may also be removed, and instead the flywheel may directly be arranged to engage with the rotary, which is further described herein. In this way, the flywheel may cause the rotary to move without the shaft.

Propeller Shaft: In the arrangement shown, as one example, the plurality of gears include a propeller shaft and/or shaft. The propeller shaft is formed of any suitable size, shape, and design and is configured to be operably connected to the flywheel and the rotary (to be further described herein) such that the shaft transfers energy from the flywheel and causes the rotary to move. In this way, the energy can be transferred throughout the system 10 and the components are operably connected, with various forces being caused by moving the components, whether the forces are applied by teeth or other components.

The shaft may also include a plurality of teeth, that operate in this way, and thus interact with the plurality of teeth of the flywheel. On the other end of the shaft, the shaft may include a converter (to be further described herein).

Converter: In the arrangement shown, as one example, the plurality of gears include a converter or cam. Cam is formed of any suitable size, shape, and design and is configured to cause the rotary (to be further described herein) to oscillate and/or move back and forth from side to side and/or from one direction to another and back and forth in a multi-directional direction and in various directions.

In the arrangement shown, as one example, the cam is configured to be a rotating or sliding piece in the mechanical system linkage transferring energy from the shaft to the rotary (to be further described herein). In this way, the cam travels along a circular path but has varying dimensions around the periphery such that the cam works with an oscillating follower, which causes motion of the rotary. In this way, and said another way, the cam can produce a smooth pulse of power to various hand tool types and/or applications. The cam in this arrangement is operably connected to the shaft and the rotary.

Directional Switch:

In the arrangement shown, as one example, spanner tool system 100 includes a directional switch. Directional switch is formed of any suitable size, shape, and design and is configured to change the direction of operation of the rotary. This may be a single direction, a bi-directional change, or a multi-directional change.

Bi-Directional Switch:

In the arrangement shown, as one example, spanner tool system 100 includes a bi-directional switch. Bi-directional switch is formed of any suitable size, shape, and design and is configured to change the direction of operation of the rotary. This may be a single direction, a bi-directional change, or a multi-directional change.

Rotary:

In the arrangement shown, as one example, spanner tool system 100 may include a rotary 60. Rotary 60 is formed of any suitable size, shape, and design and is configured to transfer energy from the cam into a rotational direction which will rotate around a bolt, a nut, or other mechanical device to induce a rotational force upon a device.

In another example, the rotary may be arranged so as to cause a repetitive hammering or the like. In this way, the rotary 60 is configured with a pendulum extension 62 which interacts with the cam so as to operably receive mechanical energy and transfer this energy to the rotation of the spinning wheel in a way that teeth can engage, disengage, and re-engage in rapid succession so that the wheel can rotate rapidly and at varying speeds.

Other Features:

Variable Speed Control: In the arrangement shown, as one example, spanner tool system 100 may also include a variable speed control. Variable speed control is formed of any suitable size, shape, and design and is configured to change the speed through which the force is emitted and/or strength of the energy applied. In this way, the variation in speed may be through pressure applied to a trigger, may be applied by a sliding lever/scale, may be applied by changes made through spinning a wheel through settings and the like.

Safety Lock: In the arrangement shown, as one example, spanner tool system 100 may also include a safety lock. Safety lock is formed of any suitable size, shape, and design and is configured to allow a user to lock and unlock the system.

Activation Trigger: In the arrangement shown, as one example, spanner tool system 100 may also include an activation trigger. Activation trigger is formed of any suitable size, shape, and design and is configured to allow a user to control the drivetrain and/or control the operation of the drivetrain.

Connections: In the arrangement shown, as one example, spanner tool system 100 may also include connections, electrical connections and other operable components and features which allow the various components to interact and/or transfer energy, forces, and the like to other components and/or features disclosed herein.

Interchangeable Head: In the arrangement shown, as one example, spanner tool system 100 may also include a plurality of interchangeable heads which are formed of any suitable size, shape, and design and are configured to fit a variety of circumstances, object shapes, and a variety of sizes of objects.

Interchangeable Battery Pack: In the arrangement shown, as one example, spanner tool system 100 may also include a plurality of interchangeable battery packs which are formed of any suitable size, shape, and design and are configured to be swapped out to continue powering the spanner tool system 100.

Display: In the arrangement shown, as one example, system 100 may also include a display (also known as graphical user interface). The display is formed of any suitable size, shape, and design and is configured to show and display information related to the use of the spanner hand tool system 100, including but not limited to data which might be reviewed by a user. In the arrangement shown, as one example, the interactive user display may be a display screen such as that found on a smartphone, tablet, or the like, and may be a touchscreen display and user interface with various options.

Processing systems: In an alternative embodiment where various torque data and the like is displayed, sensed, and more, the system may also include various processing and sub-processing systems. In this way the processing and/or sub-processing systems may include data processing, sensors, audio processing, computer processing devices, microprocessors, or other computing devices, which may include a memory, bluetooth, wireless communications, and the like.

### Alternative Embodiment

In an alternative embodiment, the above system 10 has an interchangeable head system 200. Interchangeable head system 200 (also referred to as inner module replacement) is formed of any suitable size, shape, and design and is configured to provide an interchangeable head and/or provide system 10 with different head types and/or adaptations so that system 10 can be used in a variety of applications with a variety of shapes and items. In this way, inner module replacement 200 provides and is configured to provide a quick replacement system, which requires no tools, that a user can quickly and easily change out the head.

Said another way, interchangeable head system 200 includes and provides various components which allow for an inner module to be changed out quickly. In this way, various heads can be quickly integrated into the design of system 10 so that system 10 can be used for bolts, for screws, for oddly shaped objects and can still provide the twisting, electro-mechanical oscillations, along with other movements depending on the head type being used.

In the arrangement shown, as one example, and with specific reference to the figures, inner module replacement 200 provides a system for quickly unlocking a holster access, sliding out an interchangeable head, replacing the interchangeable head, then replacing the holster access mechanism, and locking the holster system back into place.

In the arrangement shown, as one example, various sizes of the gripping planes are shown. These sizes and shapes are adjustable and various means for adjusting the head, gripping planes, and shapes, and designs are hereby contemplated for use. Some of these adjustment variations means include, but are not limited to, a plurality of bevel gears, a plurality of spur gears, a plurality of face gears, a plurality of herringbone gears, a plurality of hypoid gears, a plurality of screws, a plurality of worm gears, ratcheting, rack and pinion, clamps, friction fit, snap fit, a combination thereof, or the like.

### Alternative Embodiment (Alternative Ratchet)

In another arrangement, as shown in one example, and specifically with reference to the drawings, an alternative embodiment is presented. In the alternative embodiment, and particularly within the head system, a first prong and a second prong are included. However, the first prong and the second prong are somewhat circular in shape for functional and operational purposes.

In the arrangement, and specifically, with reference to the figures, an embodiment is presented which provides pins and/or prongs that provide for a tighter grip on the nut and/or object system 10 is being utilized on. In this way, a new prong and ratchet head is provided which provides for greater functionality in spinning and/or how the pins are extended from the interior of the head. Similarly, in this way, more levels of tightness are able to be achieved. Similarly, in this way, the grip the prongs have on the object are capable of achieving a much higher level of force. In this way, a tighter grip of the ratchet is created, with greater functionality.

In Operation/Methods of Use:

In the arrangement shown, as one example, spanner tool system 100, the drivetrain system, apparatus, and methods of use are designed to cause rotational movement and/or force, commonly about an axis. The components methods of use and functionality are various and hereby contemplated for use.

It will be appreciated by those skilled in the art that other various modifications could be made to the device without parting from the spirit and scope of this disclosure. All such modifications and changes fall within the scope of the claims and are intended to be covered thereby.

What is claimed:

1. An auto adjusting spanner tool system, comprising:
a main body;
the main body extending a length from a first end to a second end;
the main body having a hollow interior and an exterior surface forming a casement;
a motor;
the motor extending a length from a first end to a second end;
the motor having a shaft;
a plurality of gears;
the plurality of gears including a flywheel;
the plurality of gears including a plurality of teeth;
the plurality of gears including a converter;
a rotary;
the rotary having a pendulum extension feature;
the rotary having a plurality of teeth;
a tool;
the tool having an activation trigger;
the tool having a plurality of electrical connections;
a spanner;
the motor being operably connected to the power supply;
wherein power is caused to activate the motor when the activation trigger is engaged;
the motor being operably connected to the rotary;
wherein the rotary spins about a central axis when the activation trigger is engaged.

2. The system of claim 1, further comprising:
the tool having a pair of grips which extend and retract from the first prong and the second prong when engaged and disengaged;
wherein the pair of grips extend inwardly from the first prong and the second prong when being engaged a distance;
wherein the pair of grips retract outwardly from a central point and into the first prong and the second prong when being disengaged a retraction distance.

3. The system of claim 1, further comprising:
wherein the power supply is a plurality of batteries.

4. The system of claim 1, further comprising:
wherein the power supply is a plurality of rechargeable batteries.

5. The system of claim 1, further comprising:
the tool having a pair of grips which extend and retract from the first prong and the second prong when engaged and disengaged;
wherein the pair of grips extend inwardly from the first prong and the second prong when being engaged a distance;
wherein the pair of grips retract outwardly from a central point and into the first prong and the second prong when being disengaged a retraction distance;
wherein the pair of grips are extended when engaging a desired object;
wherein the pair of grips are caused to be placed into close and tight tolerances with the desired object when a user wishes to act on the desired object;
wherein once the pair of grips are engaged with the desired object, the rotary is caused to rotate, causing the desired object to rotate, thereby the tool is caused to act on the desired object.

6. The system of claim 1, further comprising:
the main body having a directional switch feature;
wherein the rotary is caused to spin in a clockwise direction when engaged;
wherein the rotary is caused to spin in a counterclockwise direction after the direction of rotation has been reversed by the activation of the directional switch feature.

7. The system of claim 1, further comprising:
the main body having at least one control feature.

8. The system of claim 1, further comprising:
the main body having an on/off feature.

9. The system of claim 1, further comprising:
the main body having an activator.

10. The system of claim 1, further comprising:
the motor having a casing.

11. The system of claim 1, further comprising:
wherein the motor is a brushless motor.

12. The system of claim 1, further comprising:
the plurality of gears operably connected to a propeller shaft.

13. The system of claim 1, further comprising:
the rotary having a plurality of catches.

14. The system of claim 1, further comprising:
the tool having a variable speed control feature;
the tool having a safety lock feature;
the tool having a pushing module and a locking module.

15. A handheld power tool, comprising:
a main body;
the main body extending a length from a first end to a second end;
the main body having a hollow interior and an exterior surface forming a casement of the main body;
the main body having an on/off switch;
the main body having an opening for accepting a plurality of batteries;
the main body having a plurality of electrical connections;
a storage compartment;
a tool head;
the tool head extending a length from a first end to a second end;
the tool head having a hollow interior and an exterior surface;
the tool head having a first prong;
the tool head having a second prong;
the tool head having a rotor,
the rotor having a plurality of teeth;
the tool head having a rotor spinner;
the tool head having a plurality of latches;
the tool head having a first grip and a second grip.

16. The system of claim 15, further comprising:
wherein the tool head is interchangeable.

17. The system of claim 15, further comprising:
the tool head having a pushing module;
the tool head having a locking module;
the tool head having a plurality of stoppers;
the tool head having a ratchet.

18. The system of claim 15, further comprising:
the main body having a variable speed switch;
the main body having an adjustment switch;
the main body having a forward switch;
the main body having a reverse switch.

19. The system of claim 15, further comprising:
the tool head having a pair of grips which extend and retract from the first prong and the second prong when engaged and disengaged;
wherein the pair of grips extend inwardly from the first prong and the second prong when being engaged a distance;
wherein the pair of grips retract outwardly from a central point and into the first prong and the second prong when being disengaged a retraction distance;
wherein the pair of grips are extended when engaging a desired object;
wherein the pair of grips are caused to be placed into close and tight tolerances with the desired object when a user wishes to act on the desired object;
wherein once the pair of grips are engaged with the desired object, the rotary is caused to rotate, causing the desired object to rotate, thereby the tool is caused to act on the desired object.

20. A method of controlling a spin spanner, comprising:
providing an automated spin spanner having:
a main body;
the main body extending a length from a first end to a second end;
the main body having a hollow interior and an exterior surface forming a casement of the main body;
the main body having an on/off switch;
the main body having an opening for accepting a plurality of batteries;
the main body having a plurality of electrical connections;
a storage compartment;
a tool head;
the tool head extending a length from a first end to a second end;
the tool head having a hollow interior and an exterior surface;
the tool head having a first prong;
the tool head having a second prong;
the tool head having a rotor,
the rotor having a plurality of teeth;
the tool head having a rotor spinner;
the tool head having a plurality of latches;
the tool head having a first grip and a second grip;
pressing an engage feature causing the first grip and second grip to engage a desired target; wherein engaging the desired target means causing the first grip and second grip to cause the desired target to be pressed between them;
releasing the engage feature when desired target is gripped between the first grip and the second grip;
pressing the activation feature, causing the rotor to rotate about a central axis, in turn, causing the desired target to rotate about a central axis.
